(19) United States
(12) Patent Application Publication
(10) Pub. No.: US 2023/0166920 A1
(43) Pub. Date: Jun. 1, 2023

(54) CONVEYOR BELT CLEANING TOOL

(71) Applicant: Luc Savoie, Bathurst (CA)

(72) Inventor: Luc Savoie, Bathurst (CA)

(21) Appl. No.: 17/994,079

(22) Filed: Nov. 25, 2022

Related U.S. Application Data
(60) Provisional application No. 63/283,388, filed on Nov. 26, 2021.

(51) Int. Cl. B65G 45/24; B65G 45/22; B65G 45/18

(52) U.S. Cl. CPC B65G 45/24; B65G 45/22; B65G 45/18; B65G 2207/26

(57) ABSTRACT

A cleaning tool is provided. The cleaning tool has an absorbent material that is elongated, a container that defines a space for holding a fluid, and a holder that is elongated, handheld, and configured to hold the absorbent material. The holder is removable from the container. It is also moveable between a first position in which the absorbent material contacts the space, and a second position in which the holder is removed from the container and the absorbent material is free to clean. The cleaning tool can be used to clean a conveyor belt.

### CROSS-REFERENCE TO RELATED APPLICATION

The present patent application claims the benefit of U.S. Provisional Patent Application Ser. No. 63/283,388, entitled “Conveyor Belt Cleaning Tool”, and filed on Nov. 26, 2021, the entire contents of which are incorporated herein by reference.

### FIELD

The subject disclosure relates generally to cleaning tools and, in particular, to a cleaning tool for cleaning a conveyor belt.

### BACKGROUND

Cleaning industrial equipment is an important part of regular operations and maintaining cleanliness. Devices such as retail conveyor belts are no exception. Given the frequency of use and volume of consumer products that come into contact with a retail conveyor belt, there is risk of accumulating dirt and of contamination to consumer products. Considering the prevalence of conveyor belts in grocery stores where food is purchased, cleanliness of a conveyor belt is desirable.

During normal day to day operations a specific check out lane in a retail or grocery store can be closed to facilitate cleaning of the conveyor belt, however this takes time and impacts productivity. Cleaning can be achieved by disinfecting a surface with a rag or paper towel. However, it may be time consuming.

Automated conveyor belt cleaning systems have been proposed. For example, U.S. Pat. No. 10,046,920 discloses a sanitation apparatus for cleaning a conveyer belt, having a housing; a float in a float chamber; a liquid reservoir; a liquid cleaning solution dispenser holding liquid cleaning solution and positioned above the housing; a tube dispensing the liquid cleaning solution into the float chamber, cleaning elements associated with the housing via a first set of compressible elements biasing the cleaning elements against the conveyer belt; a cylindrical roller connected to the housing via a second set of compressible elements biasing the cylindrical roller against the conveyer belt; the cylindrical roller being contained in the liquid reservoir such that a first portion is exposed to the liquid cleaning solution, and a second portion is in contact with the conveyer belt, engaging the cylindrical roller with the conveyer belt to cause transfer of a movement of the conveyer belt to the cylindrical roller and rotating the cylindrical roller. However, the apparatus requires installation and maintenance.

### SUMMARY

According to an aspect, there is provided a cleaning tool comprising: an absorbent material that is elongated; a container that defines a space for holding a fluid; a holder that is elongated, handheld, and configured to hold the absorbent material, the holder being removable from the container, the holder being moveable between a first position in which the absorbent material contacts the space and a second position in which the holder is removed from the container and the absorbent material is free to clean.

In some embodiments, the cleaning tool further comprises a supporting structure associated with the holder and configured to provide vertical support to the absorbent material.

In some embodiments, the supporting structure is a rod that is receivable within the absorbent material.

In some embodiments, the cleaning tool further comprises a fastener that releasably fastens the supporting structure to the holder.

In some embodiments, the supporting structure is made of a material that provides sufficient vertical support to the absorbent material under weight of the fluid that the absorbent material has absorbed over its length in use.

In some embodiments, the holder houses a portion of the absorbent material, and a remaining portion of the absorbent material protrudes from the holder.

In some embodiments, the holder holds the absorbent material in a snug fit arrangement.

In some embodiments, the holder releasably holds the absorbent material.

In some embodiments, the absorbent material and the holder being elongated comprises each of the absorbent material and the holder having a length of at least 12 inches.

In some embodiments, the container has opposite sides that vertically support the holder in the first position.

In some embodiments, the container defines the space within a cavity formed by the opposite sides of the container.

In some embodiments, edges of the holder and of the container nest in the first position.

In some embodiments, the holder fits at least partially within the container.

In some embodiments, the holder and the container form a seal in the first position.

In some embodiments, the holder has etching or a groove in opposite side walls of the holder that are configured for gripping.

In some embodiments, the absorbent material is a sponge.

In some embodiments, the absorbent material has multiple surfaces that are planar and that are switchable between multiple positions in the holder so that a different surface of the sponge contacts the space in the first position and is free to clean in the second position.

In some embodiments, the cleaning tool further comprises the fluid, wherein the fluid is a cleaning fluid.

In some embodiments, the cleaning tool further comprises a hook-and-loop fastener disposed on the container for attachment to a structure.

In some embodiments, the holder and the container are separate in the second position.

Other aspects and features of the disclosure will become apparent to those ordinarily skilled in the art upon review of the following description of specific embodiments of the disclosure.

### BRIEF DESCRIPTION OF DRAWINGS

Embodiments will now be described more fully with reference to the accompanying drawings in which:

FIG. 1 is an exploded perspective view of a cleaning tool according to one or more embodiments;

FIG. 2 is a side view of a holder of the cleaning tool;

FIG. 3 is a side view of a supporting structure of the cleaning tool;

FIG. 4 is a perspective view of an absorbent material for use with the cleaning tool; and

FIG. 5 is an exploded perspective view of a cleaning tool according to one or more embodiments.

### DETAILED DESCRIPTION

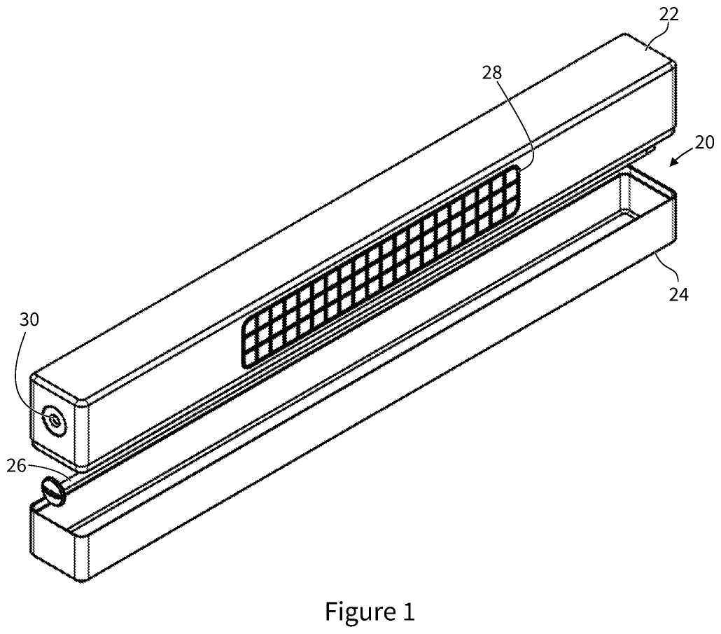

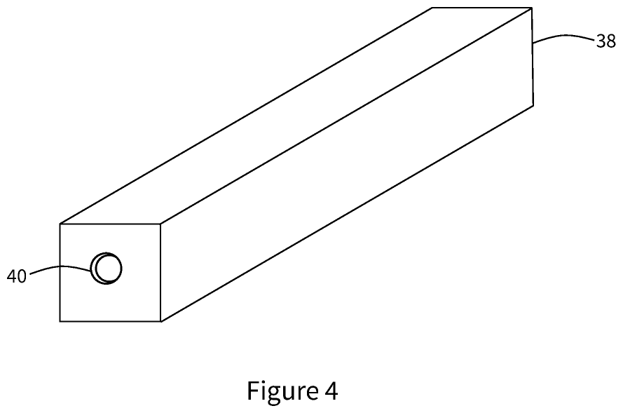

FIGS. 1 and 4 illustrate a cleaning tool 20, according to one or more embodiments. In some embodiments, the cleaning tool 20 may be configured to clean wide surfaces such as retail checkout conveyor belts (e.g., in a supermarket, retail store or other setting where there is a cash register conveyor belt for items), counters, desks, tables, and shelving. The cleaning tool may also be configured to clean self-checkout registers, keypads, or cash register keyboards.

The cleaning tool 20 may include a holder 22, a container 24, and an absorbent material 38 (shown in FIG. 4).

The absorbent material 38 may be elongated. It may be a sponge or foam.

The container 24 may define a space for holding a fluid. The fluid may be a cleaning or sanitizing fluid.

The holder 22 may be elongated, handheld, and configured to hold the absorbent material 38. For example, the holder 22 may partially house the absorbent material 38. The holder 22 may hold the absorbent material 38 in a snug fit arrangement. Alternatively, an outer surface of the holder 22 may attach to the absorbent material 38. The holder 22 may be removable from the container 24.

In use, the holder 22 may be moved between a first position in which the absorbent material 38 contacts the space and a second position in which the holder 22 is removed from the container 24 and the absorbent material 38 is free to clean. With the absorbent material 38 soaking in the liquid, in the space, the holder 22 may be removed for cleaning. The holder 22 being separate from the container 24 avoids carrying the weight of the remaining liquid held by the container 24.

The cleaning tool 20 may be used to clean a wide surface in a single action with one hand. It may save time and expense, be easy to use and economical, and afford a portable and efficient means of cleaning wide surfaces, such as a conveyor belt. It may be re-used as well.

In the example shown, the holder 22 is rectangular cuboidal and has two end walls, two side walls, and a top surface. The holder 22 is hollow and is configured to receive the absorbent material 38, such as sponge 38, so that at least a portion of the sponge 38 protrudes from the holder 22 to allow for the cleaning of a surface. In some embodiments, the holder 22 has a supporting structure 26. The supporting structure 26 may be associated with the holder 22 and configured to provide vertical support to the absorbent material 38. For example, the supporting structure 26 may be attached to the holder 22 by threaded fastener, living hinge, or snap fit. The supporting structure may vertically support the absorbent material 38 under the weight of liquid it has absorbed over its elongated length. The supporting structure 26 may be a rod, a bar, side attachments or projections. In the example shown, supporting structure 26 is a rod 26. The holder 22 further has an opening 30 in each of the end walls. The openings 30 receive the rod 26 in order to securely retain the sponge 38 once it is fitted within the holder 22.

In the example shown, the container 24 is rectangular cuboidal and has two end walls, two side walls, and a bottom surface. The container 24 is configured to hold a liquid such as a cleaning solution or disinfectant and to receive the holder 22 and sponge 38. When the holder 22 and the sponge 38 are received within the container 24 the sponge 38, protruding from the holder 22, will come into contact with the liquid in the container 24.

In the example shown, the holder 22 has a grid 28 etched into a side wall to allow a user of the cleaning tool 20 to grip the holder 22. The cells that form the grid 28 may be approximately half an inch in size. The user can hold the holder 22, using the grid 28 for grip, remove the holder 22 containing the sponge 38 from the container 24 with the liquid, and clean a surface. The user can then return the holder 22 and the sponge 38 to the container 24.

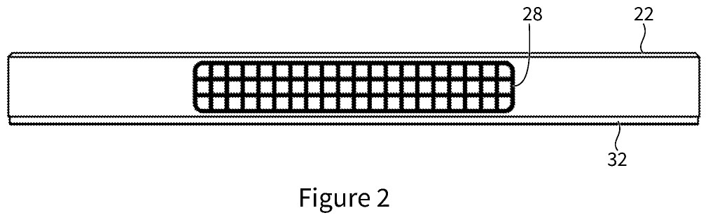

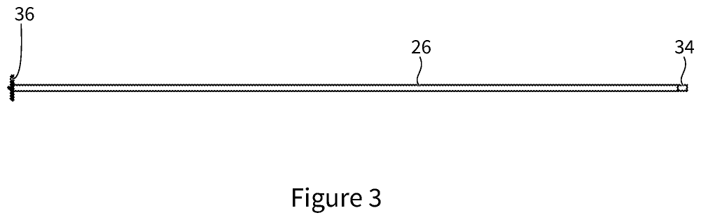

The holder 22, the supporting structure 26, and the sponge 38 may be better seen in FIGS. 2, 3, and 4. The holder 22 with the grid 28 has an edge such as recessed lip 32. The recessed lip 32 fits within the perimeter of the container 24. The rod 26 has, at one end, a screw head 36 to allow the user to screw it when securing the rod 26 to the holder 22. At the other end, the rod 26 has a screw thread 34 which, when turned, secures the rod 26, bearing the sponge 38, to the holder 22. The sponge 38 is rectangular cuboidal in shape and has an opening 40 to a passage between each end, through which the rod 26 passes.

As will be understood, when securing the rod 26 and the sponge 38 to the holder 22 the rod 26 will pass through the opening 30 in one of the end walls of the holder 22. The rod 26 then passes through the opening 40 in one end of the sponge 38, travels through the passage within the sponge 38, and then through the opening 40 at the other end of the sponge 38. Then, with turning the rod 26 by the screw head 36, the rod 26 is secured to the holder 22 through the opening 30 at the other end wall of the holder 22 with the screw thread 34. The holder 22, containing the sponge 38 secured in place by the rod 26, is then placed in the container 24 containing cleaning solution.

The sponge 38 can be rotated so that a different surface of the sponge 38 contacts the cleaning solution and can be used to clean a surface. The rod 26 is turned by the screw head 36 so the screw thread 34 turns to release the rod from the holder 22. The sponge 38 is then turned, and the rod 26 is then secured to the holder 22. This permits a surface of the sponge 38 which has been used and has become dirty to be rotated to a different surface.

The sponge 38 and the holder 22 may be sized for the wide surface it is to be applied to, which for a conveyor belt may be at least 12 inches, for example approximately 21¼ inches in length. In the example shown, the holder 22 is approximately 21¼ inches in length, 2 inches in height, with a 6 mm recessed lip 32, and 2 inches in width. The rod 26 is approximately 21¾ inches in length. The container 24 is approximately 21¾ inches in length, 1½ inches in height, and 2 inches in width.

In some embodiments, the container 24 may have a hook-and-loop fastener such as Velcro™ for attaching the bottom or sides to a structure. The fastener ensures the container 24 remains securely in place before and after the user picks up the holder 22 containing the sponge 38 to clean a surface.

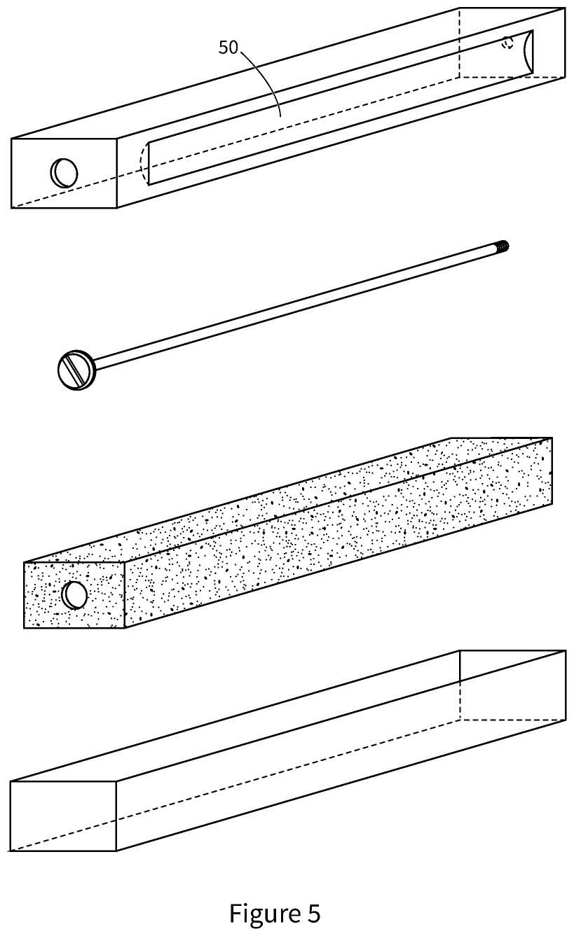

FIG. 5 illustrates a cleaning tool according to one or more embodiments. The cleaning tool may have a concave groove 50 within a side wall of the holder 22. The user can hold the holder 22, using the groove 50 for grip, and remove the holder 22 containing the sponge 38 from the container 24 with the liquid, and clean a surface.

The cleaning tool 20 may be made of plastic, carbon fiber, metal, aluminum, resin, glass, plexiglass, waxed cardboard, or other light-weight material.

Although in the embodiments described above, the shape and dimensions of the components of the cleaning tool 20 have been given, in other embodiments components may have different dimensions and be of a different shape.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

What is claimed is:

1. A cleaning tool comprising:
an absorbent material that is elongated;
a container that defines a space for holding a fluid;
a holder that is elongated, handheld, and configured to hold the absorbent material, the holder being removable from the container, the holder being moveable between a first position in which the absorbent material contacts the space and a second position in which the holder is removed from the container and the absorbent material is free to clean.

2. The cleaning tool of claim 1, further comprising a supporting structure associated with the holder and configured to provide vertical support to the absorbent material.

3. The cleaning tool of claim 2, wherein the supporting structure is a rod that is receivable within the absorbent material.

4. The cleaning tool of claim 2, further comprising a fastener that releasably fastens the supporting structure to the holder.

5. The cleaning tool of claim 2, wherein the supporting structure is made of a material that provides sufficient vertical support to the absorbent material under weight of the fluid that the absorbent material has absorbed over its length in use.

6. The cleaning tool of claim 1, wherein the holder houses a portion of the absorbent material, and a remaining portion of the absorbent material protrudes from the holder.

7. The cleaning tool of claim 6, wherein the holder holds the absorbent material in a snug fit arrangement.

8. The cleaning tool of claim 1, wherein the holder releasably holds the absorbent material.

9. The cleaning tool of claim 1, wherein the absorbent material and the holder being elongated comprises each of the absorbent material and the holder having a length of at least 12 inches.

10. The cleaning tool of claim 1, wherein the container has opposite sides that vertically support the holder in the first position.

11. The cleaning tool of claim 10, wherein the container defines the space within a cavity formed by the opposite sides of the container.

12. The cleaning tool of claim 1, wherein edges of the holder and of the container nest in the first position.

13. The cleaning tool of claim 1, wherein the holder fits at least partially within the container.

14. The cleaning tool of claim 1, wherein the holder and the container form a seal in the first position.

15. The cleaning tool of claim 1, wherein the holder has etching or a groove in opposite side walls of the holder that are configured for gripping.

16. The cleaning tool of claim 1, wherein the absorbent material is a sponge.

17. The cleaning tool of claim 1, wherein the absorbent material has multiple surfaces that are planar and that are switchable between multiple positions in the holder so that a different surface of the sponge contacts the space in the first position and is free to clean in the second position.

18. The cleaning tool of claim 1, further comprising the fluid, wherein the fluid is a cleaning fluid.

19. The cleaning tool of claim 1, further comprising a hook-and-loop fastener disposed on the container for attachment to a structure.

20. The cleaning tool of claim 1, wherein the holder and the container are separate in the second position.
